(19) United States
(12) Patent Application Publication
(10) Pub. No.: US 2010/0181013 A1
(43) Pub. Date: Jul. 22, 2010

(54) FILM FORMING METHOD AND PRODUCTION PROCESS OF LIQUID CRYSTAL DISPLAY DEVICE

(75) Inventors: Yohei Ishida, Kawasaki-shi (JP); Hirokatsu Miyata, Hadano-shi (JP); Akira Sakai, Kawasaki-shi (JP); Yasufumi Asao, Atsugi-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/090,275

(22) PCT Filed: Mar. 3, 2008
(86) PCT No.: PCT/JP2008/054229

§ 371 Date: Apr. 15, 2008

(30) Foreign Application Priority Data
Mar. 2, 2007 (JP) 2007-053253
Feb. 22, 2008 (JP) 2008-042178

(51) Int. Cl. B32B 37/00; B05D 5/12; B05D 3/06

(52) U.S. Cl. 156/182; 427/66; 427/532

(57) ABSTRACT

A method of forming a film on a substrate is constituted by a step of depositing a material vaporized from an evaporation source onto a surface of a substrate while inclining the surface of the substrate with respect to a direction from the evaporation source to the substrate, and a step of providing the surface of the substrate with an energy depending on a deposition angle.

### TECHNICAL FIELD

The present invention relates to a film forming method and a production process of a liquid crystal display device, particularly a method for forming a deposition thin film suitable for a liquid crystal alignment film on a substrate having a relatively large size and a production process of a liquid crystal display device including the method.

### BACKGROUND ART

A liquid crystal display device used for a PC monitor, a thin-shaped television, a projector, and the like has undergone variety of evolution depending on its intended purpose in recent years. The liquid crystal display device has such a constitution, as a basic structure, that a liquid crystal composition is introduced between a pair of substrates on which a pixel electrode, an opposite electrode, and an alignment film are formed although a wide variety of a liquid crystal, the alignment film, the electrodes, the substrate, and the like used therein are employed depending on uses. This constitution is common to any liquid crystal display device. Of the constitutional members, the alignment film has a function of regulating alignment of liquid crystal molecules in a certain direction. The alignment of the liquid crystal molecules in essential for the liquid crystal display device to have a switching function and therefore a characteristic of the alignment film largely affects a display characteristic of the liquid crystal display device.

As the alignment film, an organic alignment film represented by a polyimide film has been used widely. However, in a liquid crystal display device, used in an environment of high-intensity light, such as a high-brightness projector, photodeterioration of the alignment film poses a problem. This problem can be solved by using an inorganic alignment film instead of the organic alignment film.

The inorganic alignment film is generally formed by using deposition (evaporation) which is called oblique deposition. This is a method for forming a film on a substrate surface by vaporizing from an evaporation source, an inorganic material as a material for the alignment film and depositing the vaporized inorganic from an oblique direction. Specifically, in a vacuum vessel, the material is vaporized on a boat or in a crucible by resistance heating or electron beam irradiation. As the material for the inorganic alignment film, silicon oxide (SiOₓ; x=1 to 2) is frequently used. Hereinbelow, the case where the material for the inorganic alignment film is SiOₓ will be described but the present invention is also applicable to other inorganic materials.

The deposition is performed in a state in which a normal to the substrate and a line segment connecting a center of the substrate and the evaporation source are kept at a certain angle (generally called “deposition angle”), so that a film formed on the substrate microscopically has a column structure of minute SiOₓ grown in the oblique direction. The surface of the oblique deposition film having the SiOₓ column structure has a shape anisotropy corresponding to the deposition angle and the deposition direction, so that it is considered that the liquid crystal is aligned in one direction.

The inorganic alignment film formed by the oblique deposition is different in state of liquid crystal alignment depending on the deposition angle. Particularly, it is possible to control an inclination angle, called a pretilt angle of the liquid crystal molecules with respect to a direction of a normal to the alignment film by the deposition angle. The pretilt angle is a parameter largely affecting a display quality. Particularly, in order to suppress a disclination line leading to a lowering in contrast, the liquid crystal device is required to have the pretilt angle to some extent.

In order to control the pretilt angle, the deposition angle may be changed in ordinary vapor deposition but at a large deposition angle of 90 degrees, a change in pretilt angle with respect to the change in deposition angle is increased. This poses a problem when the oblique deposition is performed on a large-area substrate. That is, when the deposition is performed on the large-area substrate, a deposition angle distribution on the substrate is large, so that the pretilt angle sensitively reflects the deposition angle distribution. As a result, it is very difficult to uniformize the pretilt angle at the substrate surface.

When a diameter of the substrate is non-negligibly larger than a distance from the substrate to the evaporation source, such an angle (direction) that the evaporation source is viewed from an in-plane point of the substrate is different depending on an in-plane position, with respect to both of a polar angle and an azimuth angle. Herein, the polar angle means an angle from a normal to the substrate surface, and the azimuth angle is an in-plane angle and is taken as 0 deg. at the center of the substrate. Hereinbelow, when the evaporation source is viewed from an in-plane point of the substrate, a polar angle is referred to as a deposition angle at the point (position) and an azimuth is referred to as a deposition azimuth.

The deposition angle is, as shown by 15 to 17 in FIG. 1, larger at a closer position to the evaporation source and smaller at a position more distant from the evaporation source. On the other hand, the azimuth angle is, as shown by 91 and 92 in FIG. 9, larger at a position close to a left or right end in terms of a positive or negative value.

In-plane non-uniformity of such deposition angle and deposition azimuth causes non-uniformity of the pretilt angle, thus leading to a contrast non-uniformity, a brightness non-uniformity, and a lowering in yield of the liquid crystal display device.

The non-uniformity of the deposition azimuth can be obviated in principle as shown in FIG. 3 by performing the deposition while conveying a substrate 12 in a direction 32 perpendicular to a slit through a deposition-preventing member 21 provided with the slit along an inclination direction of the substrate 12. However, the deposition angle distribution along the slit cannot be obviated by this method. In order to decrease the deposition angle distribution, the distance between the substrate and the evaporation source is required to be increased, e.g., set to 3 m or more. In order to effect oblique deposition with such a large distance to the evaporation source, a large-size vacuum chamber is required and in order to stably retain a degree of vacuum, a necessary evacuating device or the like is additionally used, thus leading to an increase in apparatus cost.

U.S. Pat. No. 5,268,781 proposes a method of forming two (first and second) layers by oblique deposition in order to control a pretilt angle, in which the oblique deposition for the first layer is performed while irradiating a substrate with an ion beam. However, it is difficult to bombard the entire substrate surface with the ion beam at a uniform intensity when an area of the substrate is increased. Further, such an effect of compensating for a distribution of a deposition angle with respect to a substrate inclination direction is not achieved, so that it is difficult to obviate a non-uniformity of alignment due to a difference in deposition angle.

### DISCLOSURE OF THE INVENTION

A principal object of the present invention is to provide a film forming method having solved the above-described problems.

Another object of the present invention is to provide a process for producing a liquid crystal display device including the film forming method.

According to a first aspect of the present invention, there is provided a method of forming a film on a substrate, comprising:
a step of depositing a material vaporized from an evaporation source onto a surface of a substrate while inclining the surface of the substrate with respect to a direction from the evaporation source to the substrate; and
a step of providing the surface of the substrate with an energy depending on a deposition angle.

According to another aspect of the present invention, there is provided a production process of a liquid crystal display device comprising:
a step of depositing an inorganic material vaporized from an evaporation source on a surface of a substrate while inclining the surface of the substrate with respect to a direction from the evaporation source to the substrate;
a step of providing the surface of the substrate with an energy depending on a deposition angle of the inorganic material on the surface of the substrate, thereby forming a film of the inorganic material on the substrate; and
applying two substrates each on which the film of the inorganic material is formed so that their film formed surfaces are disposed opposite to each other.

According to the present invention, it is possible to easily form an inorganic alignment film, with a highly yield, such that a desired pretilt angle is uniformly exhibited over the entire surface of a deposition substrate even in the case where a large-size substrate is used and a deposition distance is relatively small. The large-size substrate may, e.g., include a substrate of 20 cm or more in diameter.

By using the film forming method of the present invention, compared with a conventional oblique deposition film production apparatus, the deposition distance can be decreased to contribute to downsizing of the production apparatus. As a result, the use of the film forming method of the present invention contributes to a reduction in production cost.

Further, according to the present invention, it is possible to provide a liquid crystal display device, set to provide a predetermined pretilt angle, capable of effecting high-quality display.

The present invention is applicable to a liquid crystal display device using an inorganic alignment film formed by using a film forming method such as oblique deposition or the like. Further, the present invention is applicable to display apparatuses using the liquid crystal display device such as a projection display apparatus such as a projector or the like, a liquid crystal monitor, a liquid crystal television, and the like.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view showing an embodiment of a constitution of an apparatus for performing oblique deposition.

FIG. 2 is a schematic view showing an embodiment of a film forming method of the present invention.

FIG. 3 is a schematic view showing an embodiment of a deposition method in the film forming method of the present invention.

FIG. 4 and FIGS. 5(a) to 5(c) are schematic views each showing an embodiment of ion beam irradiation in the film forming method of the present invention.

FIG. 6 is a schematic view showing another embodiment of the film forming method of the present invention.

FIG. 7 is a schematic view showing another embodiment of the ion beam irradiation in the film forming method of the present invention.

FIG. 8 is an explanatory view of a pretilt angle.

FIG. 9 is a schematic view showing another embodiment of the deposition method in the film forming method of the present invention.

FIGS. 10 and 11 are schematic views each showing an embodiment of providing a temperature distribution providing method.

FIGS. 12 and 13 are graphs each for illustrating an embodiment in which control of a pretilt angle is performed by ion beam irradiation.

FIGS. 14 and 15 are schematic views showing measuring positions of the pretilt angle at some points on a substrate in Example 1 and Example 3, respectively.

FIG. 16 is a graph showing changes in alignment film density and pretilt angle by ion beam irradiation in the present invention.

### BEST MODE FOR CARRYING TO THE INVENTION

The present inventors have found that a film density of an oblique deposition film and a pretilt angle have a correlation and that the film density is changed by irradiation intensity of an ion beam or substrate heating, thereby to lead to a change in the pretilt angle. Based on these foundings, it has been recognized that it is necessary to uniformize the film density of a liquid crystal alignment film in order to ensure uniformity of the pretilt angle and liquid crystal alignment in a plane of the substrate. That is, the present inventors have found that it is possible to form an oblique deposition film capable of providing uniform liquid crystal alignment by providing energy to a portion, at which the film density is low and the pretilt angle is large, thereby to locally change the film density of the oblique deposition film to uniformize the film density on the entire substrate.

Hereinbelow, the present invention will be described in detail.

A film used in the film forming method of the present invention is not particularly limited but may, e.g., include a liquid crystal alignment film, an optical thin film, etc. In the following, description will be made by using the liquid crystal alignment film.

### <Liquid Crystal Alignment Film Forming Method>

The alignment film forming method of the present invention will be descried with reference to the drawings.

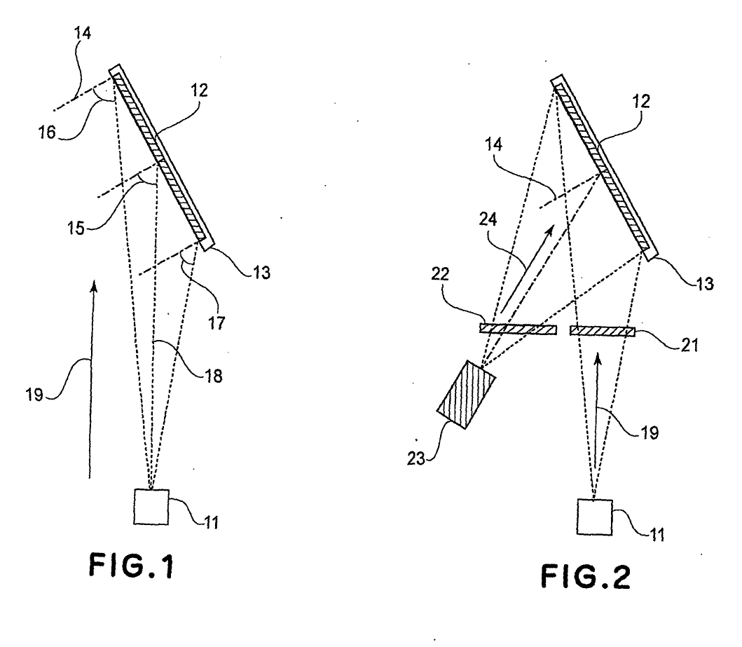

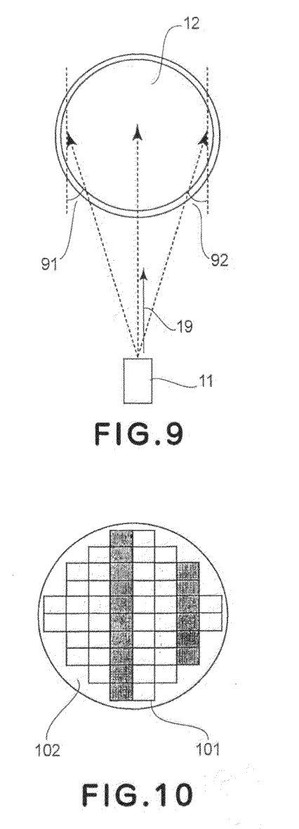

FIG. 1 shows an embodiment of an apparatus constitution in the case of performing an ordinary oblique deposition. A material vaporized or evaporated from an evaporation source 11 reaches a substrate 12 set at a certain deposition angle to form a film. During the film formation, at each point in a plane of the substrate, a deposition angle with respect to directions with respect to a polar angle and an azimuth angle is different. The material emitted from the evaporation source 11 reaches the substrate 12 with a deposition angle 15 at the center of the substrate 12, a deposition angle 16 at an upper portion of the substrate 12, and a deposition angle 17 at a lower portion of the substrate 12. Further, also with respect to an in-plane direction, as shown by azimuth angles 91 and 92 in FIG. 9, the material emitted from the evaporation source 11 reaches the substrate 12 at both end portions of the substrate 12 at angles different from that (0 deg.) at the center of the substrate 12.

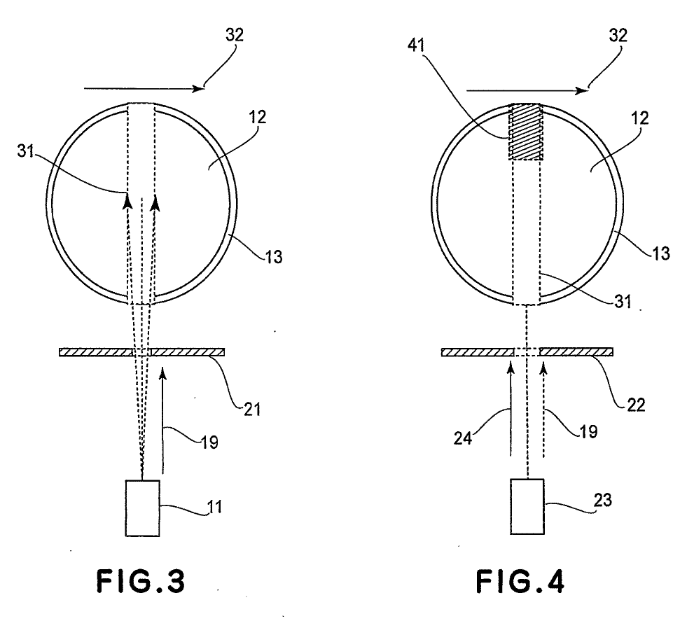

In order to prevent a deposition angle distribution with respect to the azimuth angle direction, the deposition may be performed by using a deposition preventing member 21 while moving the substrate 12 as shown in FIGS. 2 and 3. Specifically, the deposition is performed, while moving the substrate 12 in a substrate conveyance direction 32, in such a constitution that only a deposition species having an azimuth angle component in a limited range as shown by a deposition site 31 in FIG. 3 reaches the substrate 12. By this method, it is possible to prepare an oblique deposition film with a uniform azimuth angle direction.

In order to obviate the deposition angle distribution with respect to the polar angle direction, an oblique deposition film such that the same pretilt angle is provided at upper and lower portions of the substrate 12 by providing energy to a part of the substrate 12 during the oblique deposition to cause a change in formation of the oblique deposition film.

Here, the pretilt angle of liquid crystal will be described with reference to FIG. 8. In a liquid crystal display device prepared by applying glass substrates 84 each provided with a liquid crystal alignment film 83 with a spacing therebetween into which a liquid crystal consisting of liquid crystal molecules 82 is introduced, an average of values of inclination of the liquid crystal molecules 82 with respect to a normal to the substrate is referred to as a “pretilt angle”. The pretilt angle is measurable by measuring/observation methods such as a crystal rotation method, a magnetic field threshold method, a conoscope observation, and the like.

The present invention is based on the foundings that first the film density of the oblique deposition film and the pretilt angle have a correlation and that secondly the film density is changed by the irradiation intensity of ion beam or substrate heating and by this change, the pretilt angle is changed. From these foundings, it has been found that a film capable of providing uniform liquid crystal alignment by providing energy to a larger pretilt angle portion to change the energy so as to fill a gap of a sparse columnar structure, thereby to increase the film density so as to uniformize the film density on the entire substrate, in order to ensure uniformity of the pretilt angle and liquid crystal alignment in the plane of the substrate.

The film density is a weight (mass) of the film material per unit area. In the oblique deposition film of a homogeneous film material, the film density is also an index of a volume ratio between the columnar structure and its gap. Herein, the film density is defined as a volume filling ratio (%) of the columnar structure. When the oblique deposition film has no gap of the columnar structure, the film density is 100%. When the volume ratio between the columnar structure and its gas is 1:1, the film density is 50%. The film density can be determined by measurement of a refractive index of the film, measurement of spectroscopic ellipsometry, or the like.

The change in energy provided locally to a part of the substrate 12 is such a change that it affects the formation of the oblique deposition film with the result that the density of the oblique deposition film is uniformized in the plane of the substrate. This change is required to be suppressed within a range not causing non-uniformity of alignment by the pretilt angle distribution in the plane of the substrate.

As a specific method for providing the energy, it is possible to employ ion beam irradiation, substrate heating/cooling, radical/plasma irradiation, electron beam irradiation, and irradiation with ultraviolet rays, visible rays, or infrared rays. Particularly, the ion beam irradiation and the substrate heating are preferred since the energy can be easily provided locally to the substrate and effects on the structure and film density of the oblique deposition film are large thereby to retain ability of liquid crystal alignment of the oblique deposition film. In the following, these two methods will be described.

### (A): Ion Beam Irradiation

An ion source 23 for generating an ion beam is disposed at positions as shown in FIGS. 2 and 4. That is, the ion source 23 is disposed in a flat plane including a line segment connecting an evaporation source 11 and the center of a substrate 12 and a normal 14 to the substrate 12. FIG. 4 is a schematic view such that FIG. 2 is rotated 90 deg. around the line segment connecting the evaporation source 11 and the substrate 12 as an axis and that the evaporation source 11 and a deposition preventing member 21 are omitted for illustration purpose.

By irradiating a part of the substrate with the ion beam, deposition particles which have reached the substrate during the deposition are provided with energy, thus being activated. As a result, diffusion of the deposition particles on the film is accelerated to cause a change in growth of the oblique deposition film, so that the film density is locally increased. That is, by selectively irradiating a portion having a low film density with the ion beam in ordinary oblique deposition, the film density is uniformized over the entire substrate 12, with the result that it is possible to keep the pretilt angle distribution of a liquid crystal cell prepared by using the substrate 12 within an acceptable range at any point on the substrate 12.

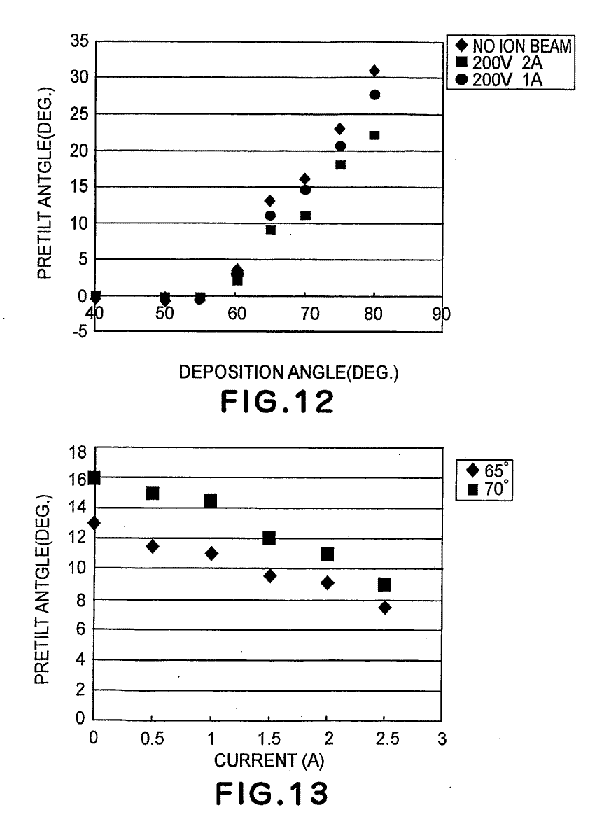

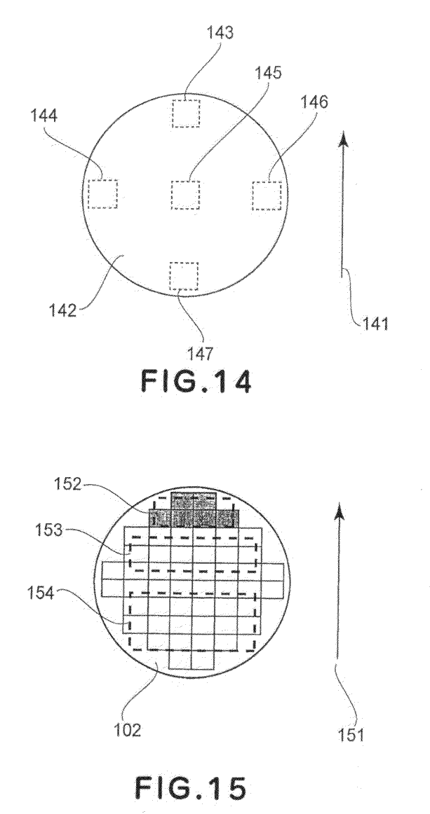

An actual Example in which control of the pretilt angle is effected by the ion beam irradiation is shown in FIGS. 12 and 13. FIG. 12 is a graph showing a relationship between the deposition angle and the pretilt angle at the time of ion beam unirradiation and irradiation of argon ion beam under a condition of an anode voltage of 200 V and an anode current of 2 A and under a condition of an anode voltage of 200 V and an anode current of 1 A. From this figure, it is possible to confirm a lowering in pretilt angle by the ion beam irradiation. FIG. 13 is a graph showing a relationship between the anode current and the pretilt angle under application of the anode voltage of 200 V at a deposition angle of 65 deg. and a deposition angle of 70 deg. It is possible to confirm that the pretilt angle is decreased with an increase in anode current both in the cases of the deposition angles 65 deg. and 70 deg.

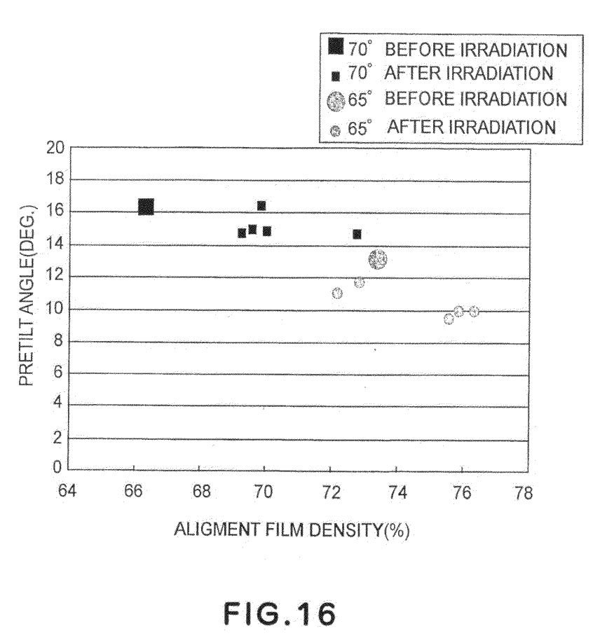

Further, FIG. 16 is a graph showing a relationship between an alignment film density and the pretilt angle at the time of the ion beam irradiation and the ion beam unirradiation at the deposition angles of 65 deg. and 70 deg. From this graph, it is understood that the pretilt angle tends to decrease with an increase in film density.

As a result of the above studies, it is understood that the pretilt angle is controllable by the anode current set with respect to the ion source. Similar studies are conducted also with respect to the anode voltage, so that similar tendency is confirmed. That is, it is clarified that the film density is increased by the increase in power of the irradiation beam and that the pretilt angle is lowered by the increase in power of the irradiation beam.

There are no limitations to an ion beam irradiation method, species of ions, and types of the ion source so long as the above-described pretilt angle lowering effect is achieved. As the irradiation ion beam, it is possible to use those of argon ion, oxygen ion, nitrogen ion, and the like or mixture ions thereof. As the ion source, it is possible to use those of an end hole type, hollow cathode type, a grid type, and the like. As the ion beam irradiation method, irradiation methods (a) and (b) described below are relatively easily applicable, thus being preferred.

### (a): Method of Changing Ion Beam Irradiation Intensity Depending on Ion Beam Irradiation Position

In the apparatus constitution shown in FIG. 2, the irradiation position is selected by using the deposition preventing member 22 capable of controlling the ion beam irradiation position and the power of the ion beam is changed depending no the selected irradiation position, so that it is possible to effect control of local growth of the oblique deposition film.

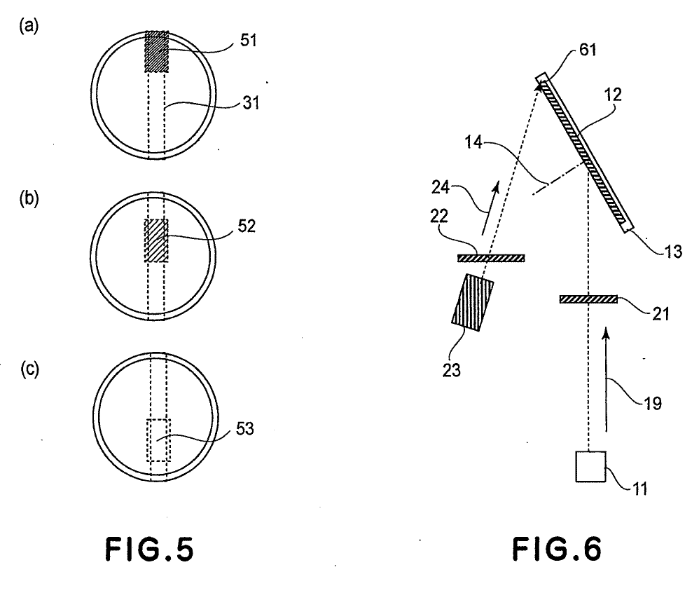

By movement of the deposition preventing member 22 provided with an opening (slit), as shown in FIGS. 5(a) to 5(c), it is possible to move the ion beam irradiation position. The shape of the opening may be any shape so long as the opening is capable of passing therethrough the ion beam with the same width as that of a deposition site (portion). By changing the ion beam irradiation intensity depending on the ion beam irradiation position, it is possible to effect more precise film density control. For example, as shown in FIG. 5, the irradiation intensity is set so be larger at an ion beam irradiation site 51, medium degree at an ion beam irradiation site 52, and smaller at an ion beam irradiation site 53. As a result, it is possible to prepare and oblique deposition film with a uniform film density over upper to lower portions of the substrate 12. While moving the substrate in the substrate conveyance direction 32, by repeating the above-described irradiation site movement, it is possible to prepare and oblique deposition film with a uniform film density over the entire surface of the substrate.

### (b): Method of Providing Ion Beam Irradiation Intensity Distribution by Setting Ion Beam Irradiation Direction to Direction Toward Upper End Portion or Above Substrate

Generally, the ion beam has an intensity distribution such that it is highest at the center of the ion beam and is gradually decrease with a radial distance from the center. By utilizing this intensity distribution, it is possible to provide different energy values to the substrate surface.

As shown in FIG. 4, when a target deposition site is an area 31, the substrate bombarded with the ion beam so that the ion beam is centered on an upper end position 41 in the area 31. The substrate is bombarded with the ion beam having the intensity distribution with respect to a radial direction at each of points in the area 31 in different radial positions, so that different energy values are provided at the positions. The beam intensity distribution or the beam irradiation angle is adjusted so as to provide an energy value corresponding to the deposition angle on the substrate.

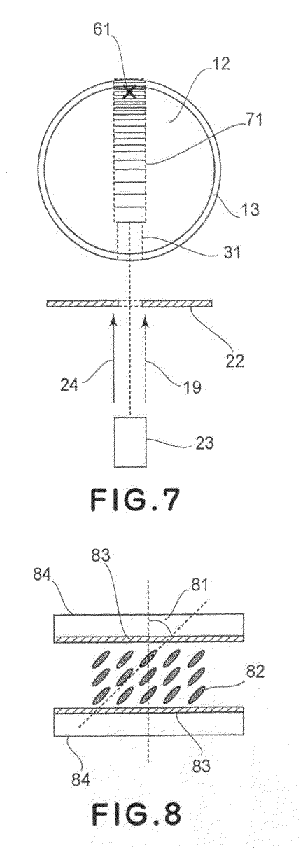

FIG. 6 is a schematic view showing the deposition apparatus shown in FIG. 4 when the apparatus is viewed from a crosswise direction. The ion beam center is set at an irradiation position 61 at the upper end portion of the substrate, so that the substrate is bombarded with the ion beam at a position radially distant from the ion beam center with a downward distance from the irradiation position 61, thus resulting in a lowering in irradiation intensity. As a result, it is possible to realize an irradiation intensity distribution as shown in FIG. 7. Specifically, the irradiation intensity is strong at the substrate upper portion and is weak at the substrate center. Further, at the substrate lower portion, the ion beam irradiation is not performed or an influence thereof is very small.

While keeping this state and moving the substrate in the horizontal direction, the oblique deposition is performed, so that it is possible to form an oblique deposition film with a uniform film density over the entire substrate surface. Depending on the intensity distribution on the substrate surface, the irradiation angle of the ion beam or a distance from the substrate is set.

### (B): Method of Providing Temperature Distribution to Substrate

It is also possible to control growth of the oblique deposition film to control the film density by providing a temperature distribution to the substrate. Specifically, thermal energy is provided to deposition species (material) flying to a heating portion by heating the substrate, thereby to activate surface diffusion of the deposition species on the substrate, with the result that the film density can be increased. Further, by cooling the substrate, the surface diffusion on the substrate is rather suppressed, so that the film density can be decreased.

The method of providing the temperature distribution on the substrate may be any method so long as the method has an effect on the growth of the oblique deposition film so that a film density distribution is uniform in an acceptable image over the entire substrate surface and that a pretilt angle distribution of a liquid crystal cell prepared by using the substrate is uniform in an acceptable range. For example, as shown in FIG. 10, it is possible to employ a method in which a substrate conveyance mechanism 102 is provided with a plurality of temperature control elements such as heaters, Peltier elements, and the like. It is also possible to use a method in which local irradiation with infrared rays or lamp heating is performed, and the like method.

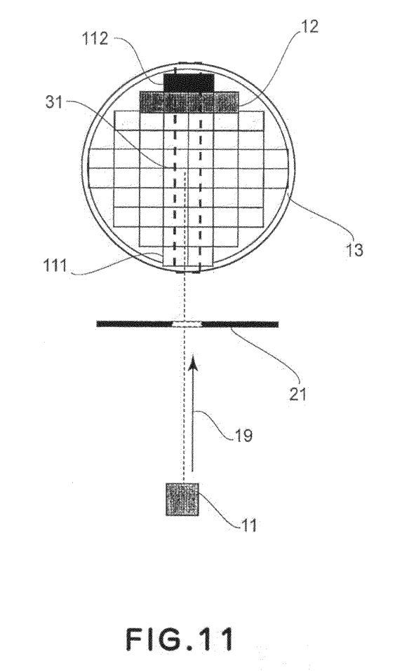

In the case where the substrate conveyance mechanism provided with the plurality of the temperature control elements, as shown in FIG. 11, a substrate temperature is set so as to be high at the substrate upper portion and low at the substrate lower portion. As a result, it is possible to ensure film density uniformization at the substrate upper and lower portions by the film growth control during the oblique deposition.

It is also possible to effect the film density uniformization of the oblique deposition film and uniformization of the pretilt angle by using the above-described methods (A) and (B) in combination. In this case, there is such an advantage that setting parameters such as set voltage, set current, set temperature, and the like can be reduced compared with the case of independently using the methods (A) and (B). Further, by the combination of the methods (A) and (B), it is possible to effect more precise film growth control and film density control.

The evaporation source 11 is not particularly limited so long as it is capable of forming the oblique deposition film on the substrate but may preferably employ a method liable to realize structural anisotropy of the oblique deposition film, such as electron beam deposition, resistance heating, or the like.

Preferred examples of the material for the oblique deposition film may include inorganic oxides including silicon oxide (SiOₓ: x=about 1 to 2) such as silicon dioxide (SiO₂) or silicon monoxide (SiO); magnesium oxide (MgO); aluminum oxide (Al₂O₃); zinc oxide (ZnO); titanium oxide (TiO₂); zirconium oxide (ZrO₂); cobalt oxide (Co₃O₄); iron oxide (Fe₂O₃ or Fe₃O₄); and fluorides such as magnesium fluoride (MgF₂) and the like. Particularly, it is desirable that the material is silicon oxide (SiO_{X}) such as silicon dioxide (SiO₂) or silicon monoxide (SiO). These inorganic materials easily form a column structure by the oblique deposition and are relatively easily controlled with respect to the film density by the above-described energy providing method.

### <Production Apparatus of Liquid Crystal Alignment Film>

The production apparatus of the liquid crystal alignment film according to the present invention is constituted by a vacuum chamber, an evacuation device for evacuating the vacuum chamber, a substrate moving mechanism for moving the substrate in the vacuum chamber, an evaporation source, a deposition preventing member for limiting an azimuth angle direction during deposition, and a device for providing energy change to deposition particles flying to the substrate.

The vacuum chamber and the evacuation device are not particularly limited so long as they can control a film forming pressure during the process so as to be kept at an appropriate pressure.

The substrate moving mechanism is a mechanism for performing setting of the deposition angle and holding and movement of the substrate in the chamber during the deposition and is not limited with respect to a constitution thereof.

The evaporation source is used for vaporizing an evaporation (deposition) source material to cause deposition species to fly to the substrate and may include those utilizing electron beam (EB) deposition, resistance heating deposition, and the like. The evaporation source material introduced into the evaporation source is not particularly limited so long as the deposited oblique deposition film provides appropriate liquid crystal alignment but may preferably include silicon oxide (SiOₓ), particularly silicon dioxide (SiO₂) from the viewpoint of performances required for a liquid crystal device.

The deposition preventing member is used for keep an angle with respect to the azimuth angle direction during the oblique deposition within a certain angle distribution. The deposition preventing member is required to be appropriately set with respect to a shape, a mounting place, and the like.

The device for providing the energy change to the deposition species flying to the substrate is required that the film density is uniformly kept at an arbitrary place of the oblique deposition film formed on the substrate and that uniformity of pretilt angles for a plurality of liquid crystal devices prepared by using the substrate is kept. As the device, it is possible to basically use any device so long as the device satisfies the above requirement but it is preferable that an ion source for generating the ion beam or a heating/cooling device for causing the substrate to bring about a partial change in temperature.

As the ion source, it is possible to use any ion source so long as the ion source is capable of realizing uniformization of the film density at any place on the substrate. For example, the ion source may be an end hole type ion source or a grid type ion source. Species of the ion beam generated from the ion source may include argon ion, oxygen ion, nitrogen ion, etc.

The heating/cooling device for causing the substrate to bring about the partial temperature change may be any device so long as the heating/cooling device can realize uniformization of the film density at any place on the substrate.

Hereinbelow, the present invention will be described more specifically with reference to Examples but is not limited thereto.

### Example 1

In this example, an inorganic alignment film is prepared by using a production apparatus having the constitution described with reference to FIG. 2 and a liquid crystal display device is prepared by using the inorganic alignment film.

In this example, the inorganic alignment film is formed by using ion beam assist deposition and oblique deposition in combination. Into an evaporation source 11, particles of silicon dioxide (SiO₂) (particle size of 1 to 2 mm) are introduced as an evaporation source material. As an ion source 23, an end hole type ion gun is used.

Next, an Si (silicon) substrate 12 having a diameter of 200 mm as a substrate is mounted on a substrate conveyance mechanism 13. On the substrate 12, a reflection electrode and a transistor for driving the liquid crystal display device are formed. A deposition angle is set to 65 deg. The deposition angle is an angle formed between a normal to the Si substrate 12 and a line segment connecting the center of the Si substrate 12 and the evaporation source 11.

Between the evaporation source 11 and the Si substrate 12, a deposition preventing member 21 provided with a fixed slit for limiting an azimuth angle distribution is disposed. Further, between the ion source 23 and the Si substrate 12, another deposition preventing member 22 provided with a slit for limiting fluxes of an ion beam emitted from the ion source 23 and controlling an irradiation position is disposed.

After the respective devices, substrate, and members are disposed as described above, a vacuum evacuation system is successively actuated to evacuate a film forming apparatus until an inner pressure is 1×10⁻⁵ Pa or less. Next, the substrate conveyance mechanism mounting thereon the Si substrate is moved to an initial position. The initial position is such a position that both of the deposition species generated from the evaporation source 11 and the ion beam fluxes generated from the ion source 23 are blocked by the deposition preventing members 21 and 22 and do not reach the Si substrate.

The evaporation source 11 is actuated to generate fluxes of deposition particles. At the time, feedback control is automatically made so that a film forming speed is 0.5 nm/s on a film thickness monitor. The film thickness monitor is located at a position, with a deposition angle of 0 deg. and a deposition distance of 1 m, at which the deposition species flying toward the Si substrate is not blocked by the deposition preventing member. Further, the ion source 23 is actuated and a flow rate of Ar gas is set so as to provide the ion source 23 with an anode voltage of 200 V, an anode current of 1.5 A, and a neutralizer current of 200 mA.

While stable keeping the above state, movement of the Si substrate is started by actuating the substrate conveyance mechanism, thus starting film formation on the Si substrate. The substrate conveyance mechanism is moved from the initial position to a deposition position as shown in FIG. 3 to permit the film formation on the Si substrate and completes the film formation on the entire Si substrate surface by reaching an end position located opposite from the initial position. The end position is, similarly as the initial position, such that the deposition species from the evaporation source and the ion beam from the ion source are blocked by the deposition preventing members and do not each the Si substrate.

Simultaneously with the film formation by actuating the substrate conveyance mechanism 13, the deposition preventing member 22 provided with the slit is moved, whereby the Si substrate is partially bombarded with the ion beam so that a deposition site 31 shown in FIG. 3 is vertically scanned. In this case, control such that an amount of the anode current is gradually decreased with a decreasing distance of the ion beam toward the substrate center by controlling the ion source so as to provide power of 200 V and 1.5 A at a position distance from the evaporation source (the ion beam irradiation position 51 shown in FIG. 5) is performed automatically. By this control, a distribution of ion beam irradiation power on the substrate is provided.

As described above, uniformity of alignment of the alignment film is improved by performing the ion beam assist deposition for changing the ion beam power depending on the irradiation position to control the ion beam power in correspondence with a length of the deposition distance and a value of the deposition angle at each point on the Si substrate.

By the above operation, the inorganic alignment film is formed on the Si substrate. In a similar manner, an inorganic alignment film is also formed on a glass substrate provided with an ITO thin film (diameter: 2 mm; size: 8 inches).

On each of the substrates, non-uniformity or the like is not confirmed through optical microscope observation, so that it is possible to confirm that the liquid crystal alignment film (inorganic alignment film) is uniformly formed on each of the substrates.

In order to confirm uniformity of a pretilt angle on the 2 mm-thick (8-inch) substrate, a liquid crystal cell for pretilt angle measurement is prepared after a deposition thin film is formed in a similar manner on each of two ITO glass substrates. The liquid crystal cell to be prepared and the pretilt angle for the liquid crystal are shown in FIG. 8. The preparation of measuring substrates is performed by cutting the two ITO glass substrates from 5 points 143 to 147 into 5 pairs of substrates and applying each pair of substrates cut from the ITO glass substrates at the same position so that deposition directions of opposing two substrates are anti-parallel to each other. Between the opposing two substrates, a liquid crystal mixture for a vertical alignment (VA) mode (“MLC-6608”, mfd. by Merck Ltd. Japan) is injected.

When the pretilt angle is measured at the 5 points 143 to 147 (taken as points A to E, respectively) on the substrate shown in FIG. 14, measured pretilt angles (P.A.) (degrees) are as shown in Table 1 below, so that it is possible to confirm the uniformity of the pretilt angle at each of the points A to E.

TABLE 1

| | Point | | | | |
|---|---|---|---|---|---|
| | A | B | C | D | E |
| P.A. (Degrees) | 10.3 | 10.5 | 10.5 | 10.3 | 10.4 |

Next, an Si substrate and an ITO glass substrate are cut from the above prepared respective substrates. Onto the Si substrate, a sealing agent containing silica beads (particle size: 3 μm) as a spacer is applied and the two substrates are applied to each other so that inorganic alignment films on the substrates are disposed in an anti-parallel constitution. Thereafter, the sealing agent is thermally cured to prepare a blank cell (into which a liquid crystal is not injected). A cell gap of the blank cell can be confirmed that it is about 3 μm at the respective points in the blank cell.

Into the blank cell, the liquid crystal mixture (MLC-6608) is injected, followed by sealing treatment. The resultant cell is heated to a nematic-isotropic phase transition temperature (91° C.) or more to effect alignment treatment. By performing the above described process, a plurality of liquid crystal display devices is prepared from the 2 mm-thick (8-inch) Si substrate and the 2 mm-thick (8-inch) ITO glass substrate.

A voltage-reflectance characteristics (V-R characteristic) of each of the liquid crystal display devices is similar one, so that it is possible to confirm that each of the liquid crystal display devices provides the same pretilt angle.

A reflection type projection apparatus is prepared by using three liquid crystal display devices prepared above.

When an image formed by using the apparatus is projected onto a screen, it is possible to effect good display free from display non-uniformity.

### Comparative Example 1

An inorganic alignment film and a liquid crystal cell are prepared in the same manner as in Example 1 except that oblique deposition is performed without using the ion beam.

When the pretilt angle is measured in the same manner as in Example 1, the following results shown in Table 2 are obtained.

TABLE 2

| | Point | | | | |
|---|---|---|---|---|---|
| | A | B | C | D | E |
| P.A. (Degrees) | 14.4 | 13.1 | 13.0 | 12.9 | 10.5 |

When the ion beam irradiation is not performed, non-uniformity in plane oblique deposition density of the substrate is caused to occur, with the result that the pretilt angles at the respective points are different from each other.

When liquid crystal display devices are prepared in the same manner as in Example 1, V-R characteristics of the liquid crystal display device prepared by using substrates close to the measuring points A (143 in FIG. 14) and E (147 in FIG. 14) are different from each other, so that it is possible to confirm that the difference in pretilt angle adversely affects a display characteristic.

### Example 2

An inorganic alignment film is prepared in the same manner as in Example 1 except that such an ion source that an irradiation intensity distribution is present in an ion beam irradiation range is used instead of such a manner that the ion beam irradiation position scanning and the irradiation amount control by the movement of the deposition preventing member 22 provided with the slit are performed. In this case, as shown in FIG. 6, an irradiation angle of the ion gun is set so that an ion current density of the ion beam is highest at a point at which the deposition distance is largest on the Si substrate, i.e., the deposition angle is smallest (ion beam irradiation position center 61 in FIG. 6). Measurement of the ion current density is performed by using an ion current monitor. Setting of the ion source includes the anode voltage of 200 V and the anode current of 1.5 A.

A liquid crystal cell is prepared by applying two substrates to each other and subjected to measurement of the pretilt angle in the same manner as in Example 1. Measurement results of the pretilt angle at the respective points on the substrate are shown in Table 3 below, so that it is understood that uniformity in pretilt angle is also ensured in this example.

TABLE 3

| | Point | | | | |
|---|---|---|---|---|---|
| | A | B | C | D | E |
| P.A. (Degrees) | 10.6 | 10.8 | 10.7 | 10.7 | 10.6 |

### Example 3

In this example, oblique deposition is performed while locally heating a substrate by a substrate heater mounted on a substrate conveyance mechanism. The temperature of the heater is set to 200° C. at a site 152, 125° C. at a site 153, and 50° C. at a site 154 on the substrate.

An inorganic alignment film is prepared on an Si substrate and an ITO glass substrate in the same manner as in Example 1 except that the ion beam is not used.

Further, the pretilt angle measurement is performed by using the same method as in Examples 1 and 2. The results are as shown in Table 4. Similarly as in Examples 1 and 2, it is possible to confirm pretilt angle uniformity also in this example.

TABLE 4

| | Point | | | | |
|---|---|---|---|---|---|
| | A | B | C | D | E |
| P.A. (Degrees) | 9.8 | 9.7 | 9.0 | 10.0 | 10.1 |

### Example 4

In this example, an inorganic alignment film is prepared by using the oblique deposition apparatus including the slit for limiting the deposition particle fluxes and the slit for limiting the ion beam fluxes used in Example 1 and using the deposition apparatus provided with the local substrate heating device using the plurality of heaters used in Example 3.

Similarly as in Example 3, the temperatures at the respective substrate sites shown in FIG. 15 are set. Specifically, the substrate temperature is set to 150 deg. at the site 152, 100° C. at the site 153, and 50° C. at the site 154. Next, in the same manner as in Example 1, the oblique deposition is performed while simultaneously effecting the ion beam irradiation intensity modulation and the scanning. At this time, ion beam intensity set values include the anode voltage of 150 V and the anode current of 2 A in the case of the largest irradiation intensity (the irradiation site 51 in FIG. 5) and the anode voltage of 150 V and the anode current 1 A in the case of the smallest irradiation intensity (the irradiation site 53 in FIG. 5).

In the case where an inorganic alignment film is prepared under the above described conditions, a pretilt angle distribution at the respective points on the substrate is as shown in Table 5 below. By simultaneously performing the substrate heating and the ion beam irradiation, it is understood that an effect similar to those in Examples 1 to 3 is obtained even in the case where the respective set values are small.

TABLE 5

| | Point | | | | |
|---|---|---|---|---|---|
| | A | B | C | D | E |
| P.A. (Degrees) | 9.6 | 9.6 | 9.7 | 9.7 | 9.5 |

### Example 5

An inorganic alignment film is prepared in the same manner as in Example 4 except that the substrate is bombarded with the ion beam in the same manner as in Example 2 instead of the ion beam scanning in Example 4. Setting during ion beam irradiation includes the anode voltage of 150 V and the anode current of 1 A. In this embodiment, the same effect as in Example 4 is achieved.

### INDUSTRIAL APPLICABILITY

According to the present invention, there is provided a film forming method capable of easily formed an inorganic alignment film providing a desired uniform pretilt angle over the entire substrate surface is large area. The film forming method is applicable to a production process of a liquid crystal display device. The thus produced liquid crystal display device is applicable to display apparatuses such as a projector, a liquid crystal monitor, a liquid crystal television, and the like.

While the invention has been described with reference to the structures disclosed herein, it is not confined to the details set forth and this application is intended to cover such modifications or changes as may come within the purpose of the improvements or the scope of the following claims.

1. A method of forming a film on a substrate, comprising:
a step of depositing a material vaporized from an evaporation source onto a surface of a substrate while inclining the surface of the substrate with respect to a direction from the evaporation source to the substrate; and
a step of providing the surface of the substrate with an energy depending on a deposition angle.

2. A method according to claim 1, wherein said energy providing step comprises a step of bombarding the surface of the substrate with a scanning ion beam, an irradiation intensity of which is changed according to the deposition angle of the material at the position of the ion beam on the surface of the substrate.

3. A method according to claim 2, wherein said scanning ion-beam bombarding step comprises a step of moving a member provided with an opening between the evaporation source and the substrate.

4. A method according to claim 1, wherein said energy providing step comprises a step of bombarding the surface of the substrate with an ion beam having a radial intensity distribution so that the ion beam at a different radial position bombards a different position of the surface of the substrate depending on a deposition angle of the material.

5. A method according to claim 1, wherein the ion beam is a beam of argon ion, oxygen ion, nitrogen ion or mixed ions thereof.

6. A method according to claim 1, wherein said energy providing step comprises a step of generating an in-plane temperature distribution of the substrate depending on the deposition angle of the material.

7. A method according to claim 6, wherein said energy providing step further comprises a step of bombarding the surface of the substrate with a scanning ion beam while changing irradiation intensity of the ion beam according to the deposition angle of the material at the position of the ion beam on the surface of the substrate.

8. A production process of a liquid crystal display device comprising:
a step of depositing an inorganic material vaporized from an evaporation source on a surface of a substrate while inclining the surface of the substrate with respect to a direction from the evaporation source to the substrate;
a step of providing the surface of the substrate with an energy depending on a deposition angle of the inorganic material on the surface of the substrate, thereby forming a film of the inorganic material on the substrate; and
applying two substrates each on which the film of the inorganic material is formed so that their film formed surfaces are disposed opposite to each other.
